(19) United States
(12) Patent Application Publication
(10) Pub. No.: US 2014/0330602 A1
(43) Pub. Date: Nov. 6, 2014

(54) Method for Multi Entity Scheduling Object Visibility and Control

(71) Applicants: Ilya William Slutsker, Plymouth, MN (US); Sasan Mokhtari, Eden Prairie, MN (US)

(72) Inventors: Ilya William Slutsker, Plymouth, MN (US); Sasan Mokhtari, Eden Prairie, MN (US)

(21) Appl. No.: 14/267,658

(22) Filed: May 1, 2014

Related U.S. Application Data
(60) Provisional application No. 61/818,012, filed on May 1, 2013.

(51) Int. Cl. G06Q 10/06

(52) U.S. Cl. CPC G06Q 10/0631
USPC 705/7.12

(57) ABSTRACT

A method for enabling a non-authoring entity viewing access to view the data associated with authored, yet un-submitted, scheduling objects comprising of the identification of an entity, or the creation and selection of an entity code; and updating scheduling object. Some embodiments of the invention not only enable the ability of an entity to view the scheduling object, but also enable the selected non-authoring entity to modify the scheduling object. An embodiment of the invention is typically paired with or a part of a larger Transaction Management System (TMS).

### CROSS-REFERENCE TO RELATED APPLICATIONS

This application claims priority to provisional patent application No. 61/818012 filed May 1, 2013, the entire contents of which are hereby incorporated by reference.

### STATEMENT REGARDING FEDERALLY SPONSORED RESEARCH

Not Applicable.

### FIELD OF THE INVENTION

The invention generally relates to transactions used for operation of electric transmission and distribution systems. Embodiments of the invention can relate to the creation and submission of North American Electric Reliability (NERC) Electronic Tags, or more commonly known as E-Tags, that are used to schedule electricity flow from one point of the power grid to another. Other embodiments of the invention can also relate to the creation and submission of other scheduling objects similar to E-tags such as Transmission Service Requests (TSRs) and pipeline Nominations.

### BACKGROUND OF THE INVENTION

While differing in purpose, both E-Tags and TSRs are both digital objects used to request and record elements needed for efficient and reliable operation of the power grid. TSRs request and record the right to use capacity from one point on the power grid to another and E-Tags request and record the schedule of the flow of the electricity through the power grid. E-Tags schedule the electricity flow through the capacity reserved by the TSRs. Additional objects similar to E-Tags and TSRs may also be used to schedule the transfer of other commodities or the reservation of capacity in other systems. Such objects, including, but not limited to, E-Tags, TSRs, and pipeline Nominations will be referred to as scheduling objects.

As the demand for energy grows over time the electric transmission and scheduling systems use to supply and support that demand must also expand. As these power systems grow the number of neighboring point to point possibilities, known as segments, increase. The end points of these segments vary in distance apart and often many segments must be used to transfer energy over longer distances; the linear chaining of these segments to cover these distances is shortened known as a path.

Due to growing energy usage the need to transfer more electricity over greater distances is also required; these paths continue to require a greater number of segments, which in turn increases their complexity. Further increasing their complexity, different entities may be responsibility for the operation of the individual segments. Often these entities must also be named on the record and receive notice of the scheduling objects.

Use of the disclosed invention helps alleviate the burden of these complexities. Using and embodiment of the invention the author of a scheduling object can allow another entity to view the data associated with a scheduling object. Author, in this context, denotes the entity that has the current authority to modify the scheduling object. The ability for multiple entities to view the same scheduling objects could aid in communication between the two entities regarding the scheduling objects and aids in the non-authoring entity's future response on the scheduling object if their response is required.

Where multiple entities are impacted by the segments and paths comprising a scheduling object, efficient submission of that scheduling object may require expertise and knowledge that is held by different users belonging to different entities. Using an embodiment of the invention disclosed, users with another company may author or modify parts of a scheduling object. This alleviates the burden of taking on the complex task on its own without the aid of the other entity or working remotely with users from another entity remotely.

### BRIEF SUMMARY OF THE INVENTION

A method for enabling an entity viewing access to authored, yet un-submitted, scheduling object, or objects, comprising of the selection of an entity code, or the creation and selection of an entity code; selection of pending time; and the updating of the object. Some embodiments of the invention may enable the entity to modify the scheduling object in addition to enabling the ability of an entity to view the scheduling object. An embodiment of the invention is typically with or a part of a larger Transaction Management System (TMS). A TMS is a system used for submitting scheduling objects for the purpose of requesting or reserving capacity or scheduling energy flow, gas, or other kinds of flows.

### BRIEF DESCRIPTION OF DRAWINGS

In the following, the present invention is explained in more detail by means of the attached drawings:

FIG. 1 is a block diagram illustrating the data flow of an embodiment of the invention wherein a non-authoring entity is provided the ability to view an authored scheduling object.

FIG. 2 is a block diagram illustrating the data flow of an embodiment of the invention wherein a non-authoring entity is provided the ability to view an authored scheduling object at the time the scheduling object is created.

FIG. 3 is a block diagram illustrating the data flow of an embodiment of the invention wherein a non-authoring entity is assigned a scheduling object.

FIG. 4 is a block diagram illustrating the data flow of an embodiment of the invention wherein a non-authoring entity is assigned a scheduling object at the time the scheduling object is created.

### DETAILED DESCRIPTION OF THE INVENTION

The invention provides a method for enabling non-authoring entities of scheduling objects the ability to view scheduling objects before they are submitted for approval or denial. Typically, the data associated with these scheduling objects is only visible to the entity that authors the scheduling object. Enabling other entities to see such data provides numerous benefits as discussed in the Background of the Invention section.

TSRs, an example scheduling object, are visible to all entities able to view the Open Access Same-Time Information System (OASIS), but only after they are submitted and are in a pending state. Up until submission, only the author of the TSR has the ability to view them.

Another example of the scheduling object, E-Tags, are typically only visible to entities named on specific elements of the tag. These entities usually consist of only the author, typically a Purchasing Selling Entity itself (PSE), the Local Control Area (LCA), the Greater Control Area (GCA), and the Transmission Provider (TP). A TMS with an embodiment of the invention often allows users and entities to store or save un submitted scheduling objects. These can be submitted later or used as templates for other future requests. Scheduling object saved or stored in this manner are often moved or changed into a status for this purpose.

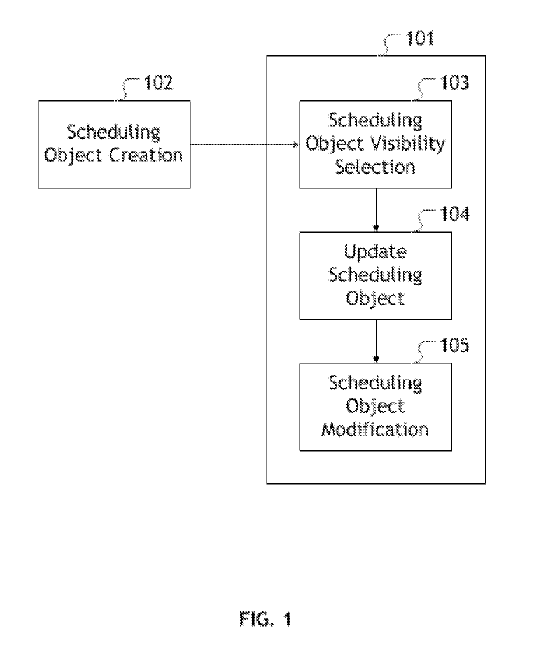

A typical embodiment of the invention, as show in FIG. 1, is located within a TMS 101. A user of the invention is a user who may be utilizing a TMS 101 to submit or take action on scheduling objects. A TMS 101, for the purpose of this application, is a system used for submitting scheduling objects for the purpose of requesting or reserving grid capacity or scheduling grid flow. The term grid, includes, but is not limited to electrical transmission and scheduling system, a gas or oil pipeline system, or similar network used for the transfer of energy, or other related commodity.

Typically, use of the invention begins when a user is viewing a scheduling object that the user or the user's entity is the author of. The user is typically viewing the scheduling object within a TMS 101. The invention allows a user to select entities the user would like to enable scheduling object visibility 103. This can be done from a pick list of possible entities. Some embodiments of the invention provide a list of the entities registered in the North American Electric Reliability Corporation (NERC) registry. To create and populate such a pick list other embodiments allow a user to manually input an entity code in such a pick list to identify the entity.

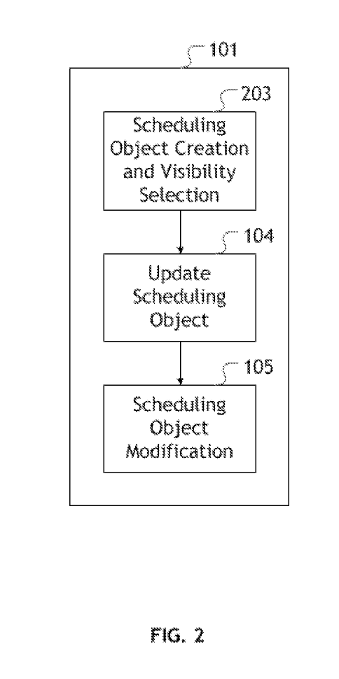

In some embodiments (FIG. 2) selection of non-authoring entities occurs as the scheduling object is being created or authored by the user 203. The selection of entities the user desired to grant visibility to can be made commensurate with the selection with the other elements needed for complete submission of the scheduling objects.

Other embodiments may allow a user to define the characteristics of authored tags that will always be visible to the non-authoring entity. This may involve the setting of criteria to which multiple scheduling objects or future scheduling objects not yet created will fulfill. The invention may then apply the visibility selection to all current and future fulfilling the set criteria.

Other embodiments may allow a user to enable multiple specific scheduling objects as visible to non-authoring entities at one time. In some embodiments the user may be able to select a scheduling object or multiple scheduling objects from a summary consisting of numerous scheduling objects.

Once the non-authoring entities have been selected by the user 103, the user must elect to update the scheduling object 104. This action saves the selection of non-authoring entities on the schedule object. Some embodiments of the invention also save any other changes the user has inputted that the TMS to be made on the scheduling object. These selected scheduling objects may then be made visible to a non-authoring entity at once through any means known in the art.

In one embodiment, immediately after the scheduling object is updated by the user 103, the invention alters the scheduling object to conform to the updated information 105. Some embodiments may append additional information to the scheduling object. Some embodiments may use specialized fields known to the TMS. In most embodiments these alterations indicate to the TMS that the non-authoring entity has the right to view the scheduling embodiment. In other embodiments the TMS will send a copy of the scheduling object to the non-authoring entity and upon any modification send an update copy of the scheduling object also to another TMS.

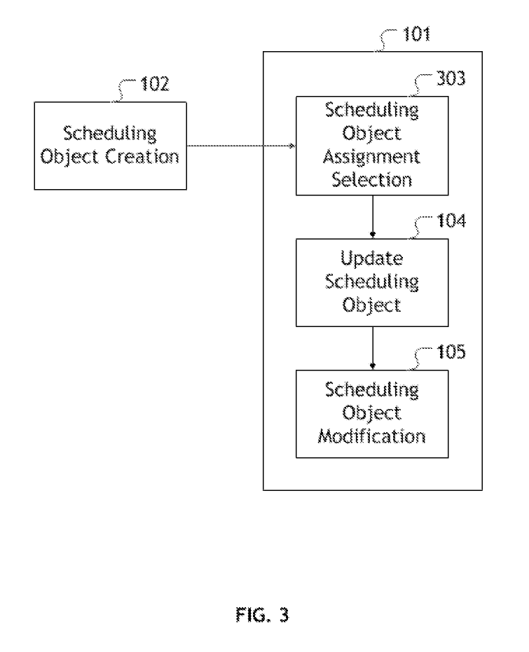

Another embodiment of the invention (FIG. 3.) allows an author of a scheduling object to assign the scheduling object to another entity. After the scheduling object has been assigned to the non-authoring entity, that entity becomes the new author of the scheduling object. The new author can act on the scheduling object as if that entity was the original author. The second author can then conduct the same actions as the first author. These actions include, but are not limited to, modification, deletion, submission, or assignation.

The invention's ability to assign the scheduling object is an extension of the inventions ability to enable a non-authoring entity to view a scheduling object. The scheduling object assignment selection 303 can occur just as scheduling object visibility selection 101 as state above occurs. Upon the update of the user the invention will alter the scheduling object to indicate to the TMS that the non-authoring entity is the new authoring entity 104. Some embodiments of the invention modify a preexisting field the TMS uses to indicate the author during scheduling object modification 105. Some embodiments of the invention will send an updated copy of the scheduling object to the new author's TMS as a scheduling object modification 105.

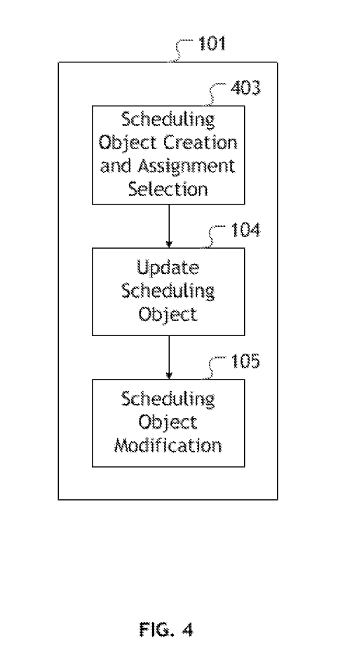

Similar to the embodiment in FIG. 2., some embodiments (FIG. 4.) assign authorship 403 of a scheduling object commensurate with the creation of a scheduling object 102.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A method for enabling non-authoring entities of scheduling objects the ability to view scheduling objects before they are submitted for approval or denial comprising the steps of;
identifying a non-authoring entity,
updating the scheduling object,
facilitating non-authoring entities to view scheduling objects.

2. The method of claim 1 wherein, the method of identifying a non-authority entity utilizes a unique entity code.

3. The method of claim 2 wherein an entity code is identified within a registry maintained by a regulatory entity or industry standards board.

4. The method of claim 2 wherein an entity code can be newly created to associate with an non-authoring entity.

5. The method of claim 1 wherein if a set of characteristics on a scheduling object qualify, visibility is permitted.

6. The method of claim 5 wherein multiple scheduling objects are associated with an entity code at one time.

7. The method of claim 5 wherein a scheduling object is an electronic tag.

8. The method of claim 5 wherein a scheduling object is a transmission service reservation.

9. The method of claim 5 wherein a scheduling object is a gas transmission notification.

10. A method for enabling non-authoring entities of scheduling objects the ability to view and attain the authority to modify scheduling objects comprising the steps of;
identifying a non-authoring entity,
updating the scheduling object,
facilitating non-authoring entities to view scheduling objects.

11. The method of claim 10 wherein, the method of identifying a non-authority entity utilizes a unique entity code.

12. The method of claim 11 wherein an entity code is identified within a registry maintained by a regulatory entity or industry standards board.

13. The method of claim 11 wherein an entity code can be newly created to associate with an non-authoring entity.

14. The method of claim 11 wherein if a set of characteristics on a scheduling object qualify, visibility and data modification are permitted.

15. The method of claim 14 wherein multiple scheduling objects are associated with an entity code at one time.

16. The method of claim 14 wherein a scheduling object is an electronic tag.

17. The method of claim 14 wherein a scheduling object is a transmission service reservation.

18. The method of claim 14 wherein a scheduling object is a gas transmission notification.
